(19) United States
(12) Patent Application Publication
(10) Pub. No.: US 2016/0047935 A1
(43) Pub. Date: Feb. 18, 2016

(54) SYSTEMS AND METHODS FOR ESTIMATION OF HYDROCARBON VOLUMES IN UNCONVENTIONAL FORMATIONS

(71) Applicant: SCHLUMBERGER TECHNOLOGY CORPORATION, Sugar Land, TX (US)

(72) Inventors: Mansoor Ali, Sugar Land, TX (US); Vivek Anand, Sugar Land, TX (US); Farid Hamichi, Sugar Land, TX (US)

(21) Appl. No.: 14/616,269

(22) Filed: Feb. 6, 2015

Related U.S. Application Data
(60) Provisional application No. 62/036,607, filed on Aug. 12, 2014.

(51) Int. Cl. G01V 3/32; G01V 3/38

(52) U.S. Cl. CPC G01V 3/32; G01V 3/38

(57) ABSTRACT

Systems and methods for evaluating a composition of a formation. A method includes obtaining a first set of well-logging data, via an NMR system, of a formation, and obtaining a second set of well-logging data, via a second well-logging system, of the formation. The method also includes determining from the first set and from the second set a model of the composition of the formation. This model of the composition of the formation may identify materials not directly identifiable by the first set of well-logging data alone or by the second set of well-logging data alone.

### CROSS-REFERENCE TO RELATED APPLICATIONS

This application claims the benefit of related U.S. Provisional Application Ser. No. 62/036,607, filed on Aug. 12, 2014, the disclosure of which is incorporated by reference herein in its entirety.

### BACKGROUND

This disclosure relates to methods for the estimation of hydrocarbon volumes in unconventional formations, such as shale formations.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of any kind.

Both water and hydrocarbons in earth formations produce detectable nuclear magnetic resonance (NMR) signals. It is desirable that the signals from water and hydrocarbons be separable so that hydrocarbon-bearing zones may be identified. However, it may not be easy to distinguish which signals are from water and which are from hydrocarbons. For example, a petrophysical challenge of shale reservoirs modeling is the estimation of producible hydrocarbon-filled porosity. The nanometer and micrometer sized pores in organic-rich shale reservoirs may contain bound water, kerogen, bitumen, and/or light hydrocarbon, among other things. While bulk density combined with spectroscopy measurements may resolve total porosity, and while resistivity or dielectric based models may provide total water-filled porosity, distinguishing, for example, kerogen from producible hydrocarbon remains a challenge. It is desirable to have improved methods that can enhance predictions of the presence of hydrocarbons in unconventional formations from NMR data. Furthermore, while two- and three-dimensional visualization has been developed to obtain primarily qualitative information, it is desirable to have quantitative interpretation techniques that can provide more accurate fluid-characterization results.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be explicitly set forth below.

One or more embodiments of the disclosure relate to well-logging using nuclear magnetic resonance (NMR) systems. A method according to the disclosure includes obtaining a first set of well-logging data relating to a formation via a nuclear magnetic resonance device. The method further includes obtaining a second set of well-logging data relating to the formation via a first downhole measurement device other than the nuclear magnetic resonance tool. The method additionally includes determining a model of a composition of the formation using the first set of well-logging data and the second set of well-logging data, wherein the model of the composition of the formation identifies a plurality of materials not directly identifiable by the first set of well-logging data alone or by the second set of well-logging data alone.

In another example, a system includes a processor. The processor is configured to receive a first set of well-logging data obtained by an NMR system of a formation. The processor is further configured to receive a second set of well-logging data obtained by a spectrographic system of the formation. The processor is additionally configured to determine a model of a composition of the formation using the first set of well-logging data and the second set of well-logging data, wherein the model of the composition of the formation identifies a plurality of materials not directly identifiable by the first set of well-logging data alone or by the second set of well-logging data alone.

The system is more particularly configured to carry out one or more of the embodiments of the method as disclosed hereafter.

Moreover, a non-transitory, tangible computer readable storage medium, comprising instructions is described. The instructions are configured to receive a first set of well-logging data obtained by an NMR system of a formation. The instructions are additionally configured to receive a second set of well-logging data obtained by a non-NMR system of the formation. The instructions are further configured to determine a model of a composition of the formation using the first set of well-logging data and the second set of well-logging data, wherein the model of the composition of the formation is identified by combining the first set of well-logging data with the second set of well-logging data.

The instructions are configured to perform one or more of the embodiments of the method as disclosed in this application.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a diagram of a downhole nuclear magnetic resonance (NMR) data acquisition system, in accordance with an embodiment;

FIG. 2 is a more detailed diagram of the system of FIG. 1, in accordance with an embodiment;

FIG. 3 is a block diagram of a pore fluid model that may be derived using the NMR data acquisition system of FIGS. 1 and 2, in accordance with an embodiment;

FIG. 4 is a flowchart of a process suitable for deriving the model of FIG. 3 and for estimating hydrocarbon volumes, in accordance with an embodiment; and

FIG. 5 is a cross-section view of an embodiment of a Combinable Magnetic Resonance (CMR) device suitable for providing more accurate NMR measurements.

### DETAILED DESCRIPTION

The disclosed subject matter describes one or more quantitative methods to interpret data modeling of an unconventional formation, such as a shale formation, by applying a joint interpretation of data from a variety of tools, such as nuclear magnetic resonance (NMR) tools, dielectric tools, resistivity tools, spectroscopy tools, and other formation modeling tools. The NMR tool may provide for NMR data, such as T1 and T2 data derived from NMR formation evaluation measurements. T1 data may include a spin-lattice relaxation time, for example, for a longitudinal (e.g., spin-lattice) recovery of a z component of nuclear spin magnetization due to NMR excitation. T2 data may include a spin-spin relaxation time, for example, for a transverse (e.g., spin-spin) relaxation of an XY component of nuclear spin magnetization due to the NMR excitation. In one embodiment, a process for inversion of estimation of hydrocarbon volumes in unconventional formations may apply a joint interpretation of NMR, dielectric, resistivity, spectroscopy and similar data, to derive a joint formation evaluation, for example, estimating a volume of certain fluids in the formation. For example, an NMR log may be used, to apply an NMR diffusion-based interpretation of the NMR log. However, the NMR diffusion-based interpretation alone may be undesirably complex due to overlapping oil and water signals in a T2 domain. The NMR diffusion-based interpretation alone may thus suffer from poor diffusion measurement resolution at short T2 intervals, as well as limited diffusion contrast between oil, water, and gas owing to their restricted diffusion in small pores (e.g., clay pores).

A Total Organic Carbon (TOC) measured, for example, via spectroscopy logging tools, may be combined with a total NMR porosity derived from the NMR log and the combination may be used to quantify, for example, a kerogen volume fraction. The TOC and NMR combinatorial method may assume that a measured NMR signal is devoid of any signal from kerogen and/or bitumen, and that substantially all of a clay bound water signal is measured. The TOC derivation alone may have poor sensitivity to distinguish kerogen from bitumen or oil. For reservoirs containing heavy oil and kerogen, interpreting fluid volumes from NMR T2 measurements may become challenging without the disclosed technique because the heavy oil and bound water signals overlap in T2 dimension. In “unconventional formations” such as shale reservoirs, although the oil and water NMR signals overlap in T2 domain, test measurements appear to demonstrate sufficient contrast in a T1/T2 ratio. According to this disclosure, a T1/T2 contrast may be used to resolve a complex pore fluid model. The techniques described herein may allow evaluation logging systems used in standard formations, such as non-shale formations, to be applied instead to unconventional formations. The logging systems may evaluate density, neutron porosity, induced-neutron spectroscopy, NMR, deep and/or shallow resistivity, and/or dielectric permittivity in the unconventional formation. For example, a water measurement system, such as a dielectric system, resistivity-based system, or any system suitable for measuring volume of water may be used with the techniques described herein. Data from the logging systems may be combined with T1/T2 derivations, as described in more detail below, to produce a joint derivation (e.g., multi-dimensional model) of the unconventional formation. The joint derivation may more accurately estimate hydrocarbon volumes in the unconventional formation. Additionally, the T1/T2 derivation may include a short T2 derivation that may more accurately model formation volumes.

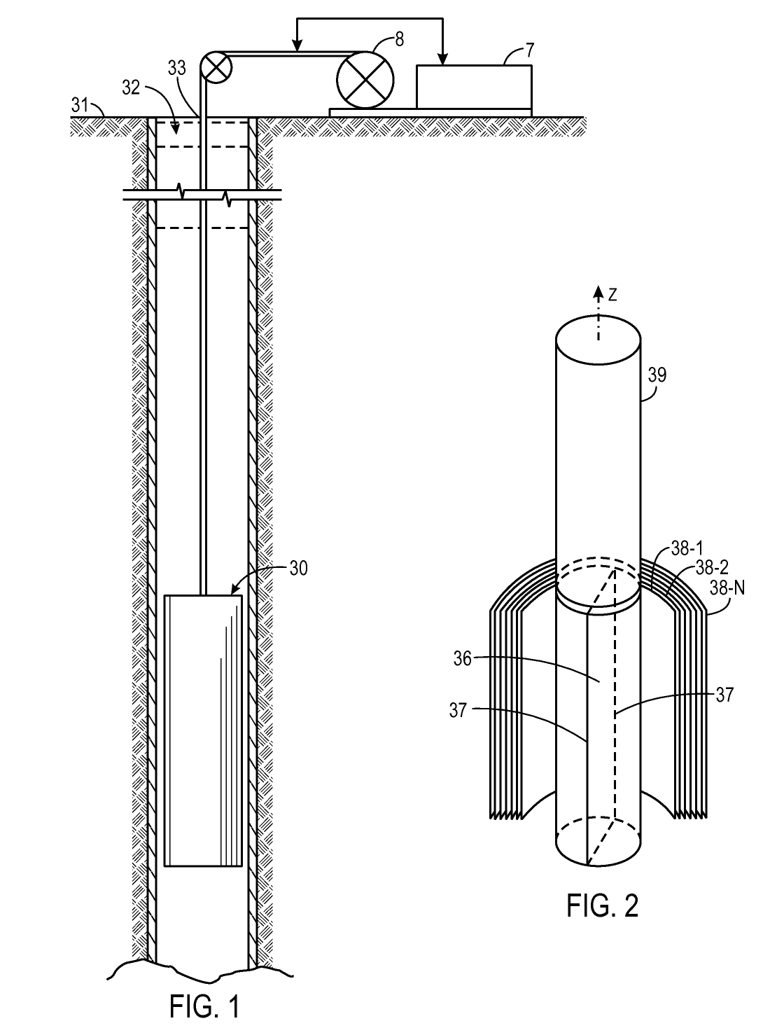

Acquisition of NMR and other measurements according to one or more embodiments described herein may be accomplished using a variety of techniques. For example, the measurements may be performed in a laboratory or in the field using a sample removed from an earth formation. Additionally or alternatively, the NMR and other measurements may be performed in a logging operation using any suitable downhole tool (e.g., a wireline tool, a logging-while-drilling and/or measurement-while-drilling tool, and/or a formation tester). FIG. 1 illustrates a schematic of an embodiment of an NMR logging system. In FIG. 1, an NMR logging tool 30 that may investigate earth formations 31 traversed by a borehole 32 is shown. The NMR logging device 30 is suspended in the borehole 32 on a cable 33 (e.g., an armored cable), the length of which may substantially determine the relative axial depth of the device 30. The cable length may be controlled by a winching device such as a drum and winch mechanism 8. Surface equipment 7 may be of any suitable type and may include a processor subsystem (e.g., a processor, memory, and/or storage) that communicates with downhole equipment including the NMR logging tool 30. The techniques of this disclosure may be carried out by the processor subsystem at the surface and/or by a processor subsystem associated with the NMR logging device 30 downhole.

The NMR logging tool 30 may be any suitable nuclear magnetic resonance logging device; it may be one for use in wireline logging applications, or one that can be used in logging-while-drilling (LWD) or measurement-while-drilling (MWD) applications. Additionally or alternatively, the NMR logging device 30 may be included in any formation tester tool, such as tools available under the trade name of MDT™ by Schlumberger Limited, of Houston, Tex. The NMR logging device 30 may include a permanent magnet or magnet array that produces a static magnetic field in the formation, and a radio frequency (RF) antenna system to produce pulses of magnetic field in the formations and to receive resulting spin echoes from the formations. The techniques for producing a static magnetic field may include a permanent magnet or magnet array, and the RF antenna system for producing pulses of magnetic field and receiving spin echoes from the formations may include one or more RF antennas.

FIG. 2 illustrates a schematic of some of the components of one type of NMR logging device 30, such as a general representation of closely spaced cylindrical thin shells, 38-1, 38-2 . . . 38-N, which may be frequency-selected in a multi-frequency logging operation. One such device is disclosed in U.S. Pat. No. 4,710,713. In FIG. 2, another magnet or magnet array 39 is shown. Magnet array 39 may be used to pre-polarize the earth formation ahead of the investigation region as the logging device 30 is raised in the borehole in the direction of arrow Z. Examples of such devices are disclosed in U.S. Pat. Nos. 5,055,788 and 3,597,681. It is to be noted that NMR data, such as logging data, may be captured from any suitable number of NMR systems, including Combinable Magnetic Resonance (CMR) systems (e.g. as described in FIG. 5), Magnetic Resonance Imager Log (MRIL) systems, Magnetic Resonance scanners, and the like. The tool 30 may thus provide data representative of T1 and T2, useful in estimating volumetric measurements of the formation.

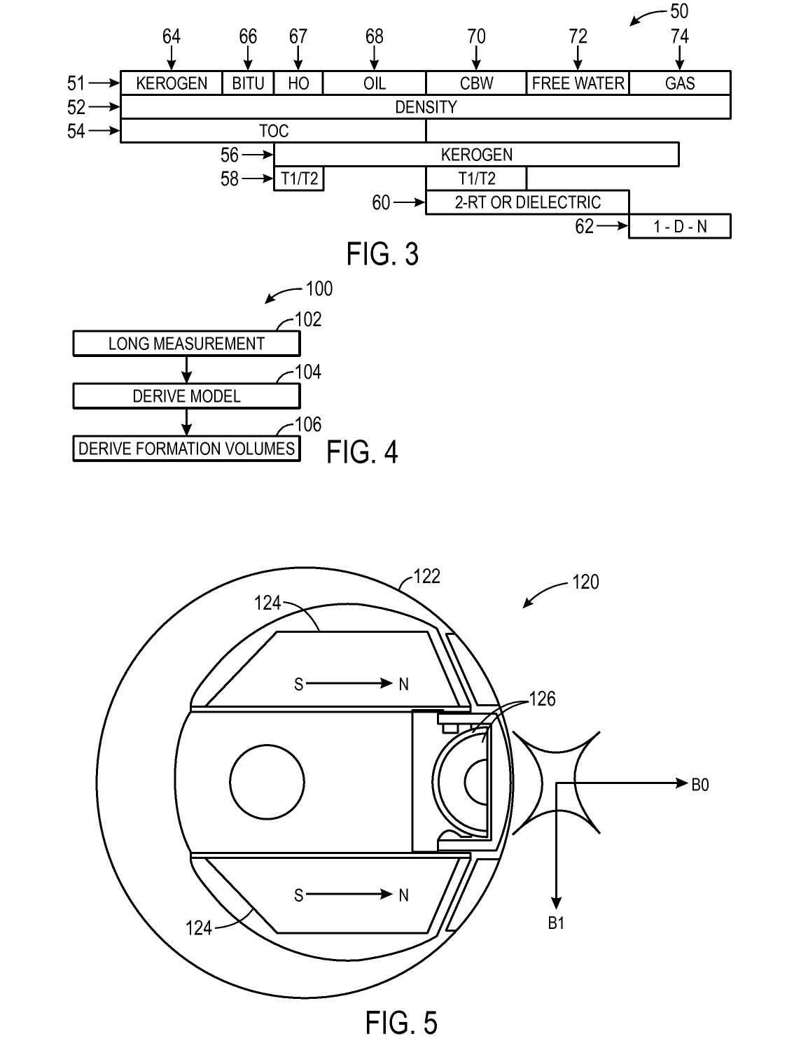

FIG. 3 depicts an embodiment of a joint derivation or multi-dimensional (e.g., multi-row) model 50 that may be derived, for example, by a sequential combination of density, neutron porosity, induced-neutron spectroscopy, NMR, deep and shallow resistivity, and/or dielectric permittivity data. The data may be derived via NMR tools such as those shown in FIGS. 1 and 2 above, and FIG. 5 below, dielectric logging tools, spectroscopy logging tools, or a combination thereof. In one example, the measurements used to provide for the joint derivations 50 include bulk density, rock or ρ matrix (RHGE), magnetic resonance porosity (MRP), T1, T2, water-filled porosity output (PWXO), total organic carbon (TOC), and neutron porosity (NPHI). The techniques described herein enable the derivation of one or more volumes of interest in a top row 51. In certain embodiments, columns 64, 66, 67, 68, 70, 72, and/or 74 of the top row 51 may be derived by using one or more measurements found in rows 52, 54, 56, 58, 60, and/or 62. Column 64 corresponds to kerogen, column 66 corresponds to bitumen, column 67 corresponds to heavy oil (HO), column 68 corresponds to oil, column 70 corresponds to clay-bound water (CBW), column 72 corresponds to free water, and column 74 corresponds to gas.

In one embodiment, the computations of rows 52, 54, 56, 60, and/or 62 may be combined with T1/T2 (e.g., row 58) in order to derive more accurate columns 64, 66, 67, 68, 70, 72, and/or 74. In one example, the equations below may then be used to build the joint derivations 50.

$$DPHI = \frac{RHGE - ρ b}{RHGE - 1} , \qquad ( 1 )$$

where DPHI is density porosity.

ρb=Vker*ρker+Vho*ρho+Vcbw*ρcbw+Vfw*ρfw+Vg*μg+Voil*ρoil (2)

MRP=Vho+Vcbw+Vfw+Voil+Vg*HI (3)

PWXO=Vcbw+Vfw (4)

TOC=Vker*ρker*DWCker+Vho*ρho*DWCho+Voil*ρoil*DWCoil+Vg*μg*DWCg (5)

T1T2ho=Vho (6)

T1T2cbw=Vcbw (7)

NPHI=Vker+Vho+Vcbw+Vfw+Voil+Vg*HI (8)

Any suitable processor subsystem (e.g., at the surface or in the downhole tool) may build the joint derivation 50 by solving the above set of equations according to the following parameters:

ρker & DWCker (density of kerogen and dry weight fraction of carbon in Kerogen): The properties of Kerogen are dependent on its maturity. Depending on maturity, the density of Kerogen may vary from 1.1 to 1.4 g/cc, whereas the dry weight fraction of carbon in kerogen may vary from less than 0.8 (oil Kerogen) to 1 (graphite).

ρho & ρoil (density of heavy oil and density of oil): This is based on composition and may be measured. Local knowledge of oil properties from a previously measured sample in the reservoir may serve as a good input.

ρcbw (density of clay bound water): A value of 1.0 g/cc may be an accurate approximation, though any other suitable value may be used.

Pfw (density of free water): This value depends on formation water salinity, which may be estimated from the dielectric measurement.

μg & HI (density and hydrogen index of gas): These two parameters may be estimated as a function of temperature and pressure.

DWCoil & DWCho (dry weight fraction of carbon in oil and heavy oil): Local knowledge of the oil composition may be used to establish the DWC parameter for oil.

DWCg (dry weight fraction of carbon in gas): This parameter may be assumed as weight fraction of carbon in methane. The parameter may be multiplied with density of gas (a small number), and thus hence the impact of any error would be small.

In other examples, the joint derivation 50 may be derived similar to solving a system of equations with N unknowns, where columns 64, 66, 67, 68, 70, 72, and/or 74 of row 51 are representative of the N unknowns. As shown, the rows under row 51 may be more particularly suited to derive one or more of the columns 64, 66, 67, 68, 70, 72, and 74. For example, T1/T2 in row 54 may be more suited for derivations of heavy oil (column 67) and clay-bound water (column 70). The rows under row 51 (e.g., 52, 54, 56, 58, 60, and/or 62) are representative of equations that may solve for one or more of the N unknowns. As more equations are solved, more of the N unknowns may be solved or may be solved with increased accuracy. Using derivations from all of the rows 52, 54, 56, 58, 60, and 62 may then result in all solving for all of the columns 64, 66, 67, 68, 70, 72, and 74 of row 51.

A more simplified approach to build the joint derivation 50 may be used in another example. Rows 52, 54, 56, 58, 60, and/or 62 may be derived. The rows 52, 54, 56, 58, 60, and/or 62 may then be used to derive the compositions or volumes 64, 66, 68, 70, 72, and/or 74 of interest. For example, the volumes of 64, 66, 68, 70, 72, and/or 74 may be viewed as columnar results of combining the rows beneath a top row. The combination may include averaging, weighted averaging, distribution via statistical techniques (e.g., Gaussian distribution, non-Gaussian distribution), via data fusion techniques, and the like. By applying the combination of data (e.g., density, neutron porosity, induced-neutron spectroscopy, NMR, deep and shallow resistivity, and dielectric permittivity data) and the derivations described with respect to joint derivation 50, a more efficient and accurate estimation of unconventional formation volumes may be provided.

Turning now to FIG. 4, the figure is a flow chart of an embodiment of a process 100 suitable for more accurately deriving unconventional formation volumes via the joint derivation or model 50 of FIG. 3. The process 100 may be executed via a hardware processor included in a computing device (e.g., a processor subsystem at the surface, in the downhole tool 30, a computer, a server, a workstation, a laptop, a smartphone, a tablet, and so forth) and implemented as non-transitory executable instructions stored in an article of manufacture that includes a computer-readable medium, such as a hard drive, flash drive, secure digital (SD) card, and so on. Additionally or alternatively, the hardware processor may be included in the NMR system described with respect to FIGS. 1, 2, and 5.

In the depicted embodiment, the process 100 may first log a variety of measurements (block 102). As mentioned earlier, the measurements may include density, neutron porosity, induced-neutron spectroscopy, NMR, deep and shallow resistivity, and dielectric permittivity measurements. The measurements may be derived using any suitable logging tools, such as the NMR system described above with respect to FIGS. 1, 2, and 5, dielectric logging tools, and/or spectroscopic logging tools. The measurements may be obtained in a single well-logging operation or may be obtained from a number of different well-logging operations that may take place at different times. Indeed, the techniques described herein may combine historical log data to derive improved measurements.

The process 100 may then produce the joint derivations or model 50 (block 104). As mentioned earlier, one or more of the rows 52, 54, 56, 58, 60, and 62, including the T1/T2 (row 58) may be used to derive one or more formation volume estimates, e.g., one or more columns 64, 66, 67, 68, 70, 72, and 74 or row 51. For example, the process 100 may apply equations 1-8 as described above with respect to FIG. 3 to derive one or more rows 52, 54, 56, 58, 60, and 62, which may be useful in deriving one or more columns 64, 66, 67, 68, 70, 72, and 74 of row 51. The process may then derive desired formation volumes (block 106), for example, as the volumes or columns 64, 66, 68, 70, 72, and/or 74 that are shown in row 51. The columns 52, 54, 56, 58, 60, and 62 of row 51 may be derived by combining the derivations of rows 52, 54, 56, 58, 60, and/or 62. In this manner, the process 100 may more efficiently and accurately estimate a variety of volumes in an unconventional formation. Additionally, as described in more detail below with respect to FIG. 5, an enhanced T1/T2 (e.g., row 58) having, for example, a “short” T2 may be used to derive more accurate T1/T2 measurements.

In one example, the short T2 may include T2 having between 0.1 and 3 milliseconds. The enhanced T1/T2 derivation incorporating the short T2 may thus be able to more accurately measure a volume, for example, when compared to using longer T2's. FIG. 5 is a top cross-sectional view of an embodiment of a Combinable Magnetic Resonance (CMR) tool 120 shown disposed inside of a bore wall 122 that may be used to derive the enhanced T1/T2 measurements. The CMR tool 120 may include memory suitable for storing executable instructions or computer code, which may be executed in one or more processors of the CMR tool 120. An example CMR tool 120 is available under the trade name of CMR-Plus™ by Schlumberger Limited, of Houston, Tex. The CMR tool 120 may use a pulse acquisition sequence referred to as an Enhanced Precision Mode (EPM). In EPM, one long wait time pulse sequence may be followed by one or more short wait time pulse sequences. EPM may improve the precision of the data associated with fast relaxing components, such as water disposed in pores, small pore heavy crude oils, and the like. In this mode EPM it may be possible to derive a more precise T1 and/or T2 distribution, improving the precision of bound-fluid volume and porosity observations (e.g., row 58, columns 67, 70).

The CMR tool 120 may include two permanent magnets 124, and a RF antenna 126, suitable for NMR measurements. In particular, the antenna may more accurately measure an area of interest 128 via the aforementioned EPM pulse acquisition sequence. Accordingly, the T1/T2 ratio may more accurately derive volumes for heavy oil (column 67, row 58), and/or clay-bound water (CBW) (column 70, row 58). Applying the enhanced T1/T2 in combination with one or more of the rows 52, 54, 56, 60, and 62 may thus provide for more accurate measurements of columns 64, 66, 67, 68, 70, 72, and 74 of row 51. Indeed, by combining T1/T2 with additional measurements, the techniques described herein may more accurately and efficiently derive volumetric information for a variety of formations, including shales.

Although only a few example embodiments have been described in detail above, those skilled in the art will readily appreciate that many modifications are possible in the example embodiments without materially departing from “Systems and Methods for Estimation of Hydrocarbon Volumes in Unconventional Formations.” Features shown in individual embodiments referred to above may be used together in combinations other than those which have been shown and described specifically. Accordingly, all such modifications are intended to be included within the scope of this disclosure. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of the any of the claims herein, except for those in which the claim expressly uses the words ‘means for’ together with an associated function.

What is claimed is:

1. A method for evaluating at least one volume of a formation, the method comprising:
obtaining a first set of well-logging data relating to a formation via a nuclear magnetic resonance device;
obtaining a second set of well-logging data relating to the formation via a first downhole measurement device other than the nuclear magnetic resonance tool; and
determining a model of a composition of the formation using the first set of well-logging data and the second set of well-logging data, wherein the model of the composition of the formation identifies a plurality of materials not directly identifiable by the first set of well-logging data alone or by the second set of well-logging data alone.

2. The method of claim 1, comprising obtaining a third set of well-logging data relating to the formation via a second downhole measurement device other than the nuclear magnetic resonance device or the first downhole measurement device, wherein the model is determined combining the first set of well-logging data, the second set of well-logging data, and the third set of well-logging data.

3. The method of claim 2, wherein the first set of well-logging data comprises a T1 measurement and a T2 measurement and wherein the second set of well-logging data comprises a bulk density, a rock or ρ matrix (RHGE), a magnetic resonance porosity (MRP), a water-filled porosity output (PWXO), a total organic carbon (TOC), a neutron porosity (NPHI), or a combination thereof.

4. The method of claim 1, wherein the first set of data comprises a T1 measurement and a T2 measurement, and wherein the model comprises a T1/T2 component to identify a volume of the formation.

5. The method of claim 1, wherein the formation comprises a shale formation, and wherein the composition of the formation comprises one or more volumes of a kerogen, a bitumen, a heavy oil, an oil, a clay-bound water, a free water, and a gas.

6. The method of claim 1, wherein the nuclear magnetic resonance device comprises a Combinable Magnetic Resonance (CMR) device.

7. The method of claim 6, wherein the first set of well-logging data comprises a T1 and a T2 obtained via an Enhanced Precision Mode (EPM) pulse acquisition sequence.

8. The method of claim 7, wherein the pulse acquisition sequence comprises one long-wait-time pulse sequence followed by two or more stacked short wait-time pulse sequences.

9. A system, comprising:
a processor configured to:
receive a first set of well-logging data obtained by an NMR system of a formation;
receive a second set of well-logging data obtained by a spectrographic system of the formation; and
determine a model of a composition of the formation using the first set of well-logging data and the second set of well-logging data, wherein the model of the composition of the formation identifies a plurality of materials not directly identifiable by the first set of well-logging data alone or by the second set of well-logging data alone.

10. The system of claim 9, wherein the processor is included in the NMR system.

11. The system of claim 9, wherein the processor is configured to receive a third set of well-logging data obtained by a water measurement system configured to measure a volume of water, and to determine the model using first set, the second set, and the third set.

12. The system of claim 11, wherein the first set of well-logging data, the second set of well-logging data, the third set of well-logging data, or a combination thereof, comprises a bulk density, a rock or ρ matrix (RHGE), a magnetic resonance porosity (MRP), a T1, a T2, a water filled porosity output (PWXO), a total organic carbon (TOC), a neutron porosity (NPHI), or a combination thereof.

13. The system of claim 9, wherein the first set of well-logging data comprises a T1/T2, and wherein the T2 comprises a T2 of less than 3 milliseconds.

14. The system of claim 9, wherein the NMR system comprises a Combinable Magnetic Resonance (CMR) device configured to provide a T1 and a T2.

15. The system of claim 14, wherein the CMR device is configured to execute an Enhanced Precision Mode (EPM) pulse acquisition sequence to derive the T1 and the T2.

16. The system of claim 15, wherein the pulse acquisition sequence comprises one long-wait-time pulse sequence followed by two or more stacked short wait-time pulse sequences.

17. A non-transitory, tangible computer readable storage medium, comprising instructions configured to:
receive a first set of well-logging data obtained by an NMR system of a formation;
receive a second set of well-logging data obtained by a non-NMR system of the formation; and
determine a model of a composition of the formation using the first set of well-logging data and the second set of well-logging data, wherein the model of the composition of the formation is identified by combining the first set of well-logging data with the second set of well-logging data.

18. The storage medium of claim 17, wherein the first set of well-logging data comprises a T1 and a T2.

19. The storage medium of claim 17, wherein the second set of well-logging data comprises a spectrographic data set, a dielectric data set, or a combination thereof.

20. The storage medium of claim 17, wherein the first set of well-logging data comprises a T1/T2 derived by a pulse acquisition sequence comprising one long-wait-time pulse sequence followed by two or more stacked short wait-time pulse sequences
